(19) United States
(12) Patent Application Publication
(10) Pub. No.: US 2024/0351231 A1
(43) Pub. Date: Oct. 24, 2024

(54) AUTOMATIC POTATO-CUTTER MACHINE

(71) Applicant: SHUANGMA PLASTIC MANUFACTURING INC., Taizhou (CN)

(72) Inventors: Cuihong CHEN, Taizhou (CN); Kaibo ZHANG, Taizhou (CN); Haoming XU, Taizhou (CN); Wenjun YANG, Taizhou (CN)

(21) Appl. No.: 18/318,569

(22) Filed: May 16, 2023

(30) Foreign Application Priority Data
Apr. 18, 2023 (CN) 202310419025.4

(51) Int. Cl. B26D 3/26

(52) U.S. Cl. CPC B26D 3/26

(57) ABSTRACT

The present invention discloses an automatic potato-cutting machine, which includes a casing, a base and a push plate. The casing is arranged on the top of the base, a first installation groove is on one side of the casing, and a first buckle is arranged on one side of the first installation buckle. A shielding structure is arranged on the top of the side plate. In the present invention, a blade is movably connected inside the installation housing, and the blade and the installation housing form a snap-fit structure, so that the blade can be snapped into the inside of the installation housing, and then the first installation buckle can slide inside the first installation groove, the sliding of the first installation buckle can drive the first buckle to move, and the movement of the first buckle can be snapped into the slot on the blade.

### CROSS REFERENCE TO RELATED APPLICATIONS

This application claims foreign priority of Chinese Patent Application No. 202310419025.4, filed on Apr. 18, 2023 in the China National Intellectual Property Administration, the disclosures of all of which are hereby incorporated by reference.

### TECHNICAL FIELD

The disclosure relates to the technical field of potato processing, and more particularly to an automatic potato-cutter machines.

### TECHNICAL BACKGROUND

There are still some problems in the existing automatic potato-cutter, and the specific problems are as follows:

1. It is difficult to disassemble the blade of the automatic potato-cutter machine. The blade will be worn during processing, and the blade needs to be cleaned after long time use. This requires disassembly of the blade to replace or clean.

2. The automatic potato-cutter machine has the problem that it is difficult to rotate the baffle. The baffle will affect the feeding of potatoes. It is necessary to rotate the baffle to facilitate feeding of potatoes.

### SUMMARY OF THE INVENTION

### (1) Technical Issues to be Resolved

The present invention is to provide a new automatic potato-cutter machine to solve the defects of the existing potato-cutter machine that it is difficult to disassemble the blade and rotate the baffle.

### (2) Summary of the Invention

To solve the above technical problems, the present invention provides the following technical solutions: an automatic potato-cutter machine, comprising a casing, a base and a push plate, and the top of the base is provided with the casing;

The bottom of the casing is provided with a movable structure, a motor is arranged in the casing, a telescopic push rod is arranged on one side of the motor, and a fixed rod is arranged on the top of one side of the casing. One push plate is arranged on the side of the telescopic push rod.

The side plates are arranged at both ends of the push plate, a blade is arranged on one side of each of the side plates, and a disassembly structure is arranged on one side of the blade.

When using the device, the hinge can rotate along the rotating shaft at first; the rotation of the hinge can drive the connecting rod to rotate; the rotation of the connecting rod can drive the baffle to rotate; the baffle can be opened or closed, which is convenient for potato feeding, and potatoes can be loaded into the machine, then the motor works to drive the telescopic push rod to expand and contract, the telescopic push rod stretches to drive the push plate to move, the push plate moves to drive the potatoes to move, and the potatoes can be moved through the blade and be cut.

Preferably, the disassembly structure comprises a first installation buckle, a first installation groove, a first buckle, a handle and a mounting housing, the mounting housing is mounted on the outside of the blade, the first installation groove is mounted on one side of the mounting housing, the inside of the first installation groove is movably connected with a first installation buckle, a first buckle is arranged on one side of the first installation buckle, and a shielding structure is arranged on the top of the side plate.

Preferably, the outer diameter of the push plate is smaller than the inner diameter of the side plate, the push plate and the side plate form a sliding structure, and the push plate can slide.

Preferably, a mounting screw is arranged on one side of the fixing rod, external threads are evenly positioned on the outer wall of the mounting screw, internal threads that cooperate with the external threads are evenly positioned on the inner wall of the fixing rod, so the mounting screw and the fixing rod are threadedly connected, and the fixing rod can be arranged and fixed by the mounting screw.

Preferably, the mounting housing and the blade form a snap-fit structure, the inner diameter of the mounting shell is larger than the outer diameter of the blade, and the snap-fit structure is convenient for disassembly.

Preferably, the shielding structure comprises a baffle, a hinge, a connecting rod and a rotating shaft, the hinge is arranged on the top of the housing, a rotating shaft is arranged inside the hinge, a connection rod is arranged on one side of the hinge, a baffle is arranged on one side of the connecting rod, the hinge can rotate along the rotating shaft, the rotation of the hinge can drive the connecting rod to rotate, the rotation of the connecting rod can drive the baffle to rotate, and the baffle can be opened or closed, It is convenient for potatoes to be fed, and it is convenient for the machine to be used.

Preferably, a connection structure is arranged on one side of the housing, the connection structure comprises a second mounting buckle, a second mounting groove, a second buckle and a limited block, the limited block is arranged on one side of the housing, one side of the limited block is provided with a second installation groove, one side of the second installation groove is movably connected with a second installation buckle, one side of the second installation buckle is provided with a second buckle, the position limited block and the housing form a snap-fit structure, the limited block can limit the fixed rod and the blade, the second installation buckle can slide inside the second installation groove, the sliding of the second installation buckle can drive the second buckle to snap into the limited block, then the limited plate is fixed. The limited plate can be removed by pulling the second buckle. After the limited plate is removed, a part of the fixing rod can be stored inside the housing.

Preferably, one side of the limited block is provided with a clamping block, one side of the housing is provided with a slot, and the limited block and the housing form a snap-fit structure, which is easy to disassemble.

Preferably, one side of the second installation buckle is provided with a slider, one side of the second installation groove is provided with a slide groove, the second installation buckle and the second installation groove form a sliding structure, and the second installation buckle can slide inside the second installation groove.

Preferably, the movable structure comprises a plate body, a rotating shaft, a positioning block, a wheel and a fixed buckle. The plate is arranged on the bottom of the housing, the bottom of the plate is provided with a rotating shaft, a positioning block is arranged at the bottom of the rotating shaft, a wheel is arranged at the bottom of the positioning block, and a fixed buckle is arranged on one side of the wheel. The device can move through the wheel, and the wheel can be fixed through the fixing buckle.

### (3) Beneficial Effect

The automatic potato-cutter machine installed by the invention has the advantages of: a blade is movably connected inside the installation housing, the blade and the installation housing form a snap-fit structure, so that the blade can be snapped into the inside of the installation housing, then the first installation buckle can slide inside the first installation groove, the sliding of the first installation buckle can drive the first buckle to move, and then the first buckle moves and is snapped into the slot on the blade. The first buckle can fix the blade. When the replacement of the blade is necessary, the user can move the first installation buckle until the installation buckle no longer blocks the blade, the user can grab the handle and pull the blade out of the installation housing to replace the blade, so as to achieve the purpose of easy disassembly of the blade of the automatic potato-cutter machines.

By installing a limited block on one side of the housing, the limited block and the housing form a snap-fit structure, the limited block can limit the fixed rod and the blade, the second installation buckle can slide inside the second installation groove, and the second installation buckle can drive the second buckle to snap into the limit block to fix the limit plate. Pulling the second buckle, and then the limit plate can be removed. After the limit plate is removed, a part of the fixed rod can be stored into the casing, easy storage of the automatic potato-cutter machine is achieved.

By installing a hinge on the top of the housing, the hinge can rotate along the shaft, the rotation of the hinge can drive the connecting rod to rotate, the rotation of the connecting rod can drive the baffle to rotate, and the baffle can be opened or closed, which is convenient for the feeding of potatoes, so as to achieve the purpose of adjusting the angle of the baffle for the automatic potato-cutter machine.

### DESCRIPTION OF DRAWINGS

To more clearly illustrate the embodiments of the present invention or the prior art, and the following will briefly introduce the drawings that need to be used in the description of the embodiments or the prior art. Obviously, the accompanying drawings in the following description are for some embodiments of the present invention, those skilled in the art can also obtain other drawings based on these drawings without creative work.

FIG. 1 is the front view sectional structure schematic diagram of the present invention;

FIG. 2 is a top view sectional structure schematic diagram of the present invention;

FIG. 3 is a schematic diagram of a partial section enlarged structure at a place in FIG. 4 of the present invention;

FIG. 4 is a schematic diagram of a three-dimensional structure of the present invention;

FIG. 5 is a schematic diagram of a partial cross-sectional structure of a shielding structure of the present invention;

FIG. 6 is a side view sectional structure schematic diagram of the present invention;

FIG. 7 is a schematic diagram of a three-dimensional structure of the present invention;

FIG. 8 is a schematic diagram of a partial cross-sectional front view of the mobile structure of the present invention.

Description of reference numerals in the figure: 1. Casing; 2. Motor; 3. Telescopic push rod; 4. Base; 5. Push plate; 6. Blade; 7. Disassembly structure; 701. First installation buckle; 702. First installation groove; 703. First buckle; 704. Handle; 705. Installation housing; 8. Fixed rod; 9. Installation screw; 10. Shielding structure; 1001. Baffle; 1002. Hinge; 1003. Connection rod; 1004. Rotating shaft; 11. Side plate; 12. Connection structure; 1201. Second installation buckle; 1202. Second installation slot; 1203. Second buckle; 1204. Limited block; 13. Movable structure; 1301. Body; 1302. Rotating shaft; 1303. Positioning block; 1304. Wheel; 1305. Fixed buckle.

### DETAILED DESCRIPTION OF THE INVENTION

In order to ensure the purpose, technical solutions and advantages of the embodiments of the present invention clearer, and the technical solutions in the embodiments of the present invention will be clearly and completely described below in conjunction with the drawings in the embodiments of the present invention. Obviously, the described embodiments are a part of embodiments of the present invention. Based on the embodiments of the present invention, all other embodiments obtained by persons of ordinary skill in the art without creative efforts fall within the protection extent of the present invention.

In the description of the present invention, it should be noted that unless otherwise specified and limited, the terms “installation”, and “connection” should be understood in a broad sense, for example, it can be a fixed connection or a detachable connection, or integrally connected; It may be mechanically connected or electrically connected; It may be directly connected or indirectly connected through an intermediary, and it may be the internal communication of two components. Those of ordinary skill in the art can understand the specific meanings of the above terms in the present invention.

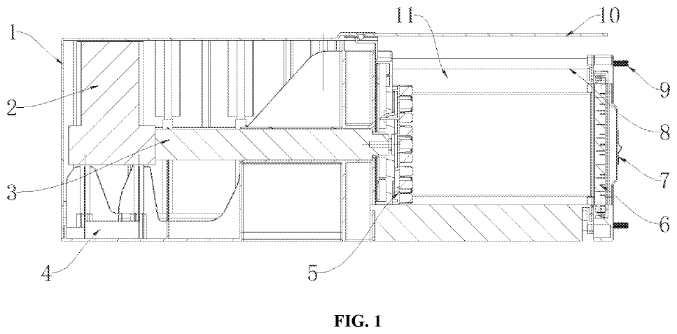

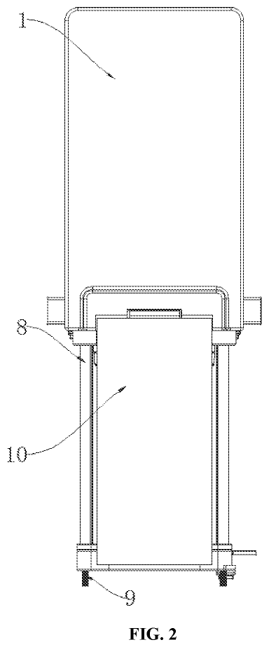

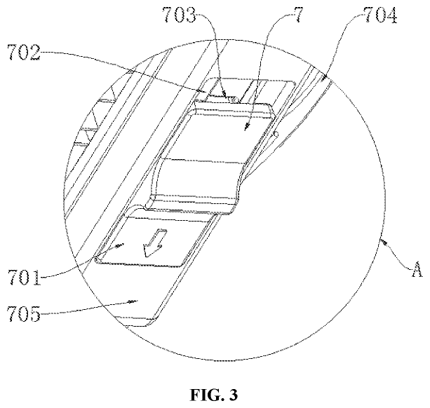

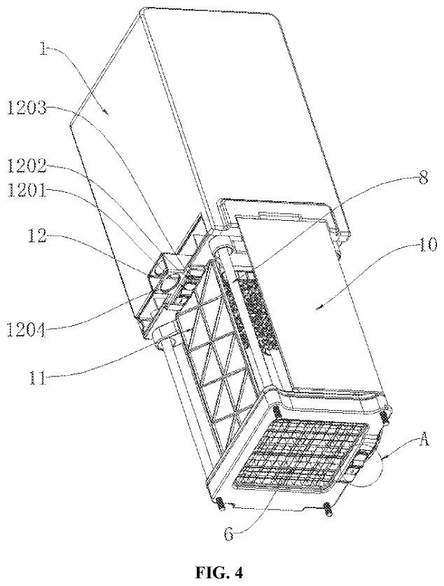

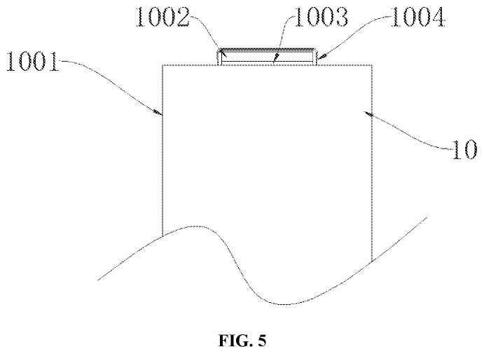

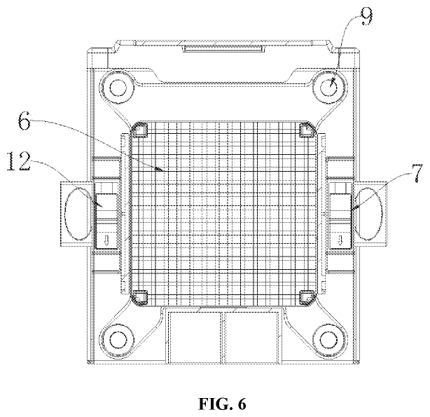

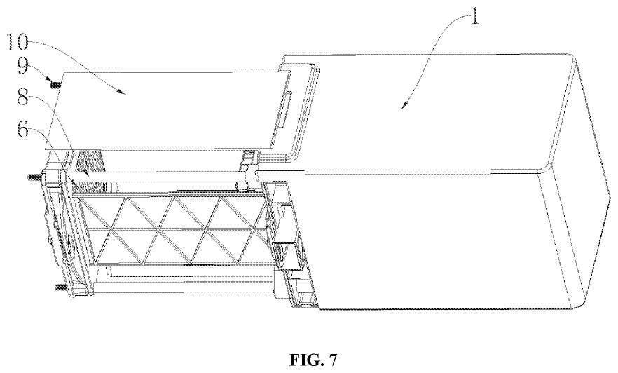

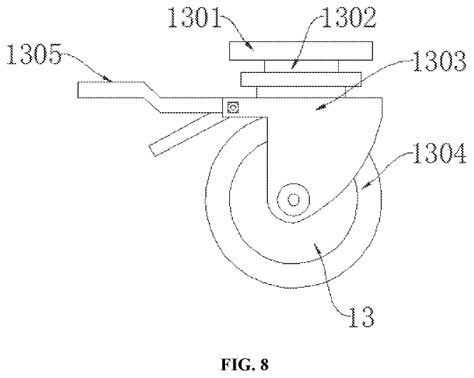

Referring to FIGS. 1-8, an embodiment of the present invention is an automatic potato-cutter machine, which comprises a casing (1), a base (4) and a push plate (5), and the top end of the base (4) is mounted with the casing (1).

The bottom end of the casing (1) is provided with the movable structure (13); the movable structure (13) comprises the plate body (1301), the rotating shaft (1302), the positioning block (1303), the wheel (1304) and the fixed buckle (1305); the plate body (1301) is arranged on the bottom of casing (1); the rotating shaft (1302) is arranged at the bottom of the plate body (1301); the positioning block (1303) is arranged at the bottom of the rotating shaft 1302; the wheel (1304) is arranged at the bottom of the positioning block (1303); a fixed buckle (1305) is arranged on one side of the wheel (1304).

When using the movable structure (13), at first the rotating shaft (1302) at the bottom end of the plate body (1301) can rotate; the rotating shaft (1302) can drive the positioning block (1303) to rotate; the rotating of the positioning block (1303) can drive the rotating wheel (1304) to rotate, and the wheel (1304) can adjust the movement and direction of the device. When the wheel (1304) is fixed, the fixed buckle (1305) can fix the wheel (1304).

The motor (2) is arranged inside the casing (1); a telescopic push rod (3) is installed on one side of the motor (2); a connection structure (12) is arranged on one side of the casing (1); the connection structure (12) comprises a second mounting buckle (1201), a second mounting groove (1202), a second buckle (1203) and a limited block (1204), and the limited block (1204) is arranged on one side of the casing (1); one side of the limited block 1204 is provided with a limited block, and one side of the casing (1) is provided with a limited slot, and the limited block (1204) and the casing (1) to form a snap-fit structure.

One side of the limited block (1204) is provided with a second installation groove (1202), and one side of the second installation groove (1202) is movably connected with a second installation buckle (1201), and one side of the second installation buckle (1201) is provided with a slider, and the second installation groove (1202) is provided with a slide groove. The second installation buckle (1201) and the second installation groove (1202) form a sliding structure, and one side of the second installation buckle (1201) is provided with a second buckle (1203).

Embodiment 1: firstly, the limited block (1204) and the casing (1) form a snap-fit structure, and the limited block (1204) can limit the fixed rod (8) and the blade (6), and the second mounting buckle (1201) can slide inside the second mounting groove (1202), and the sliding of the second installation buckle (1201) can drive the second buckle (1203) into the inside of the limited block (1204) to fix the limited plate, and pull the second buckle (1203), and then the limited plate can be removed. After the limited plate is removed, a part of the fixed rod (8) is housed inside the casing (1).

The top end of one side of the casing (1) is provided with a fixed rod (8), and one side of the fixed rod (8) is provided with a mounting screw (9), and the outer wall of the mounting screw (9) is evenly provided with external threads, and the inner wall of the fixed rod (8) is evenly provided with external threads. The internal threads that cooperate with each other, the mounting screw (9) and the fixing rod (8) are threaded.

One side of telescopic push rod (3) is provided with the push plate (5), and the outer diameter of the push plate (5) is less than the inner diameter of the side plate (11), and the push plate (5) and the side plate (11) form a sliding structure.

Both ends of the push plate (5) are provided with the side plate (11), and the blade (6) is arranged on one side of the side plate (11), and one side of the blade (6) is provided with the dismounting structure (7), and the dismounting structure (7) comprises the first mounting buckle (701), the second mounting groove (702), a first buckle (703), a handle (704) and a mounting housing (705), and the mounting housing (705) is arranged on the outside of the blade (6), the mounting housing (705) and the blade 6 form a snap-fit structure, and the inner diameter of the mounting shell (705) is larger than the outer diameter of the blade (6).

The first installation groove (702) is arranged on one side of the installation housing (705), and the inside of the first installation groove (702) is movably connected with a first installation buckle (701), and one side of the first installation buckle (701) is provided with a first buckle (703), and the first installation slot (702) and the first installation buckle (701) form a sliding structure, and the inner diameter of the first installation slot (702) is larger than the outer diameter of the first installation buckle (701).

Embodiment 2: firstly, the blade (6) and the mounting housing (705) form snap-fit structure, and the snap-fit structure is easy to disassemble, and the blade 6 can be snapped into the interior of mounting housing (705), and then first mounting buckle (701) can be carried out inside the first mounting groove (702). The sliding of the first installation buckle (701) can drive the first buckle (703) to move, and the movement of the first buckle (703) can be snapped into the slot on the blade (6), and the first buckle (703) can fix the blade (6), and when the blade (6) need the replacement, the first installation buckle (701) is moved and doesn't fix the blade (6), and the handle (704) can be grasped to extract the blade (6) from the inside of the installation housing (705) to replace the blade (6).

The top of the side plate (11) is provided with a shielding structure (10), the shielding structure (10) comprises a baffle (1001), a hinge (1002), a connection rod (1003) and a rotating shaft (1004), and the hinge (1002) is arranged on the top of the casing (1), and the rotating shaft (1004) is installed inside the hinge (1002), and the connection rod (1003) is arranged on one side of the hinge (1002), and a baffle (1001) is arranged on one side of the connection rod (1003).

Embodiment 3: firstly, the hinge (1002) can rotate along the rotating shaft (1004); the rotation of the hinge (1002) can drive the connection rod (1003) to rotate; the rotation of the connection rod (1003) can drive the baffle (1001) to rotate; the baffle (1001) can be opened or closed; then potatoes is easily fed. Potatoes can be loaded into the device; then the motor (2) works to drive the telescopic push rod (3) to expand and contract; the telescopic push rod (3) stretches to drive the push plate (5) to move, and potatoes are past the blade (6) and cut.

In the description of the present invention, it should be noted that unless otherwise specified and limited, the terms “provide”, and “connection” should be understood in a broad sense, for example, it can be a fixed connection or a detachable connection, or integrally connected; It may be mechanically connected or electrically connected; It may be directly connected or indirectly connected through an intermediary, and it may be the internal communication of two components. Those of ordinary skill in the art can understand the specific meanings of the above terms in the present invention.

The embodiments described above are only illustrative, and the units described as separate components may or may not be physically separated, and the components shown as units may or may not be physical units, that is, it may be located in one place, or it can be distributed to multiple network elements. Part or all of the modules can be selected according to actual needs to achieve the purpose of this embodiment. It can be understood and implemented by those skilled in the art without any creative efforts.

Finally, it should be noted that: the above embodiments are only used to illustrate the technical solutions of the present invention, rather than to limit them; although the present invention has been described in detail with reference to the foregoing embodiments, those of ordinary skill in the art should understand that: the modifications also can be made to the technical solutions described in the foregoing embodiments, or equivalent replacements are made to some of the technical features; and these modifications or replacements do not make the essence of the corresponding technical solutions deviate from the spirit and scope of the technical solutions of the various embodiments of the present invention.

1. An automatic potato-cutter machine, comprising a casing (1), a base (4) and a push plate (5), wherein a top of the base (4) is provided with the casing (1);
a movable structure (13) is arranged at a bottom of the casing (1), a motor (2) is arranged inside the casing (1), and a telescopic push rod (3) is arranged on one side of the motor (2); a fixed rod (8) is arranged on a top of one side of the casing (1), and a push plate (5) is arranged on one side of the telescopic push rod (3);
both ends of the push plate (5) are provided with side plates (11), respectively; one side of the side plate (11) is provided with a blade (6), and one side of the blade (6) is provided with a disassembly structure (7).

2. The automatic potato-cutter machine according to claim 1, wherein the disassembly structure (7) comprises a first installation buckle (701), a first installation groove (702), a first buckle (703), a handle (704) and an installation housing (705); the installation housing (705) is arranged outside the blade (6), and the first installation groove (702) is arranged on one side of the installation housing (705); a first installation buckle (701) is movably connected inside the installation groove (702); the first buckle (703) is arranged on one side of the first installation buckle (701), and a shielding structure (10) is arranged a top of the side plate (11).

3. The automatic potato-cutter machine according to claim 1, wherein an outer diameter of the push plate (5) is smaller than an inner diameter of the side plate (11), and the push plate (5) and the side plate (11) form a sliding structure.

4. The automatic potato-cutter according to claim 1, wherein a plurality of mounting screws (9) is arranged on one side of the fixing rod (8); an outer wall of the mounting screws (9) comprises an external thread; an inner wall of the fixing rod (8) comprises an internal thread cooperating with the external thread, and the mounting screws (9) are in threaded connection to the fixing rod (8).

5. The automatic potato-cutter machine according to claim 2, wherein the mounting housing (705) and the blade (6) form a snap-fit structure, and an inner diameter of the mounting housing (705) is larger than an outer diameter of the blade (6).

6. The automatic potato-cutter machine according to claim 2, wherein the shielding structure (10) comprises a baffle (1001), a hinge (1002), a connection rod (1003) and a rotating shaft (1004); the hinge (1002) is arranged on a top of the casing (1), the rotating shaft (1004) is arranged inside the hinge (1002), one side of the hinge (1002) is provided with a connection rod (1003), and a baffle (1001) is arranged on one side of the connection rod (1003).

7. The automatic potato-cutter machine according to claim 1, wherein a connection structure (12) is arranged on one side of the casing (1), the connection structure (12) comprises a second installation buckle (1201), a second installation groove (1202), a second buckle (1203) and a limited block (1204); the limited block (1204) is arranged on one side of the casing (1), one side of the limited block (1204) is provided with the second installation groove (1202), one side of the second installation groove (1202) is movably connected to the second installation buckle (1201), and the second buckle (1203) is arranged on one side of the second installation buckle (1201).

8. The automatic potato-cutter machine according to claim 7, wherein one side of the limited block (1204) is provided with a clamping block, one side of the casing (1) is provided with a clamping slot, and the limited block (1204) and the casing (1) form a snap-fit structure.

9. The automatic potato-cutter according to claim 7, wherein one side of the second installation buckle (1201) is provided with a slider, one side of the second installation groove (1202) is provided with a slider slot, and the second installation buckle (1201) and the second installation groove (1202) form a sliding structure.

10. The automatic potato-cutter machine according to claim 1, wherein the movable structure (13) comprises a plate body (1301), a rotating shaft (1302), a positioning block (1303), a wheel (1304) and a fixed buckle (1305); the plate (1301) is arranged on the bottom of the casing (1); a bottom of the plate body (1301) is provided with a rotating shaft (1302); the positioning block (1303) is arranged at a bottom of the rotating shaft (1302); the wheel (1304) is arranged at a bottom of the positioning block (1303), and a fixed buckle (1305) is arranged on one side of the wheel (1304).
